(19) United States
(12) Patent Application Publication
(10) Pub. No.: US 2017/0043859 A1
(43) Pub. Date: Feb. 16, 2017

(54) TRAILING EDGE COMPONENTS, AIRCRAFT STRUCTURES INCLUDING TRAILING EDGE COMPONENTS AND METHODS FOR MANUFACTURING TRAILING EDGE COMPONENTS

(71) Applicant: Gulfstream Aerospace Corporation, Savannah, GA (US)

(72) Inventors: Brenden Autry, Savannah, GA (US); Bryan Williams, Savannah, GA (US); Travis Cope, Savannah, GA (US); Susan Daggett, Savannah, GA (US); Mike McKee, Savannah, GA (US); Francis Russo, Savannah, GA (US); Charles Aitken, Savannah, GA (US)

(21) Appl. No.: 14/824,273

(22) Filed: Aug. 12, 2015

(51) Int. Cl. B64C 3/28; B64C 23/06; B64C 9/00; B64C 3/26

(52) U.S. Cl. CPC B64C 3/28; B64C 3/26; B64C 23/065; B64C 9/00

(57) ABSTRACT

Trailing edge components of aircraft structures, aircraft structures comprising such trialing edge components, and methods of manufacturing such trailing edge components are provided. In an exemplary embodiment, a trailing edge component includes a first skin comprising a first plurality of plies of carbon fiber reinforced polymer material and having a first mating region. The first plurality of plies includes a first ply with a first drop-off edge in the first mating region. A second skin includes a second plurality of plies of carbon fiber reinforced polymer material and having a second mating region affixed to the first mating region.

### TECHNICAL FIELD

The technical field generally relates to trailing edge components for use with aircraft, aircraft structures comprising trailing edge components, and methods for manufacturing the same. More particularly, the technical field relates to trailing edge components of carbon fiber reinforced polymer material, aircraft structures comprising such trailing edge components, and methods of manufacturing the trailing edge components.

### BACKGROUND

Like all components of modern aircraft, wings and winglets are combinations of specialized parts designed for manipulating and controlling lift and other aerodynamic forces. Typically, wings and winglets each include upper and lower skins opposed to one another and forming the upper and lower external surfaces of the wing or winglet, respectively. Wings and winglets each have a root end and a distal end extending opposite the root end. The root end of a wing is adapted for securely affixing the wing to the airplane body. The root end of a winglet is adapted for securely affixing the winglet to the distal end of a wing. A winglet increases the efficiency of the wing to which it is affixed by reducing drag that would otherwise be induced by wing tip vortices.

In addition to the upper and lower skins, wing structures such as wings and winglets typically have a trailing edge component that generally extends the length of the wing structure. The trailing edge component contributes to the aerodynamic properties of the wing structure. FIG. 1 is a partial perspective view of an aircraft 10 showing a typical location of a trailing edge component 12 of a winglet 18. More particularly, the aircraft 10 includes a pair of wings 14, 16, only one of which 14 is fully shown and has the winglet 18 affixed thereto. FIGS. 2 and 3 are enlarged views of a portion of the wing 14 with the trailing edge component 12 affixed to an aft edge 20 of the winglet 18. The aft edge is the rearward back edge located closest to the tail of the aircraft.

The trailing edge component 12 has an upper skin 13 and a lower skin 15 with skin surface contours that are dictated substantially by pre-determined aerodynamic properties. FIG. 4 is a simplified cross-section view, taken along line 4-4 of FIG. 3, and illustrates the winglet 18 coupled to the trailing edge component 12. Fore edges 11 of the upper skin 13 and lower skin 15 of the trailing edge component 12 are coupled to an upper skin 17 and a lower skin 19, respectively, of the winglet 18. The aft edges 21 of the upper and lower skins 13, 15 of the trailing edge component 12 are mated, joined, or otherwise affixed to one another to form a sealed trailing edge 22 of the trailing edge component 12 and, hence, the winglet 18. Today, the trailing edge components of wing structures are commonly made of metal, such as aluminum or aluminum alloy. FIG. 5 is a close-up illustration of a conventional mating of the aft edges 21 of the upper and lower skins 13, 15 of the trailing edge component 12 of FIG. 4. The upper and lower skins 13, 15 are typically formed of sheet metal and are joined together by a metallic wedge 9. The skins 13, 15 are attached to the metallic wedge 9 by fasteners. Metal trailing edge components are heavy and add undesirable weight to an aircraft.

Accordingly, it is desirable to provide trailing edge components of carbon fiber reinforced polymer materials configured in a manner such that aerodynamic properties of the trailing edge components are not adversely affected. It also is desirable to provide aircraft structures comprising such trailing edge components. In addition, it is desirable to provide methods for manufacturing such trailing edge components. Furthermore, other desirable features and characteristics of the methods and apparatus contemplated herein will become apparent from the subsequent detailed description of the invention and the appended claims, taken in conjunction with the accompanying drawings.

### BRIEF SUMMARY

Trailing edge components of aircraft structures, aircraft structures comprising such trialing edge components, and methods of manufacturing such trailing edge components are provided. In an exemplary embodiment, a trailing edge component includes a first skin comprising a first plurality of plies of carbon fiber reinforced polymer material and having a first mating region. The first plurality of plies includes a first ply with a first drop-off edge in the first mating region. A second skin includes a second plurality of plies of carbon fiber reinforced polymer material and having a second mating region affixed to the first mating region.

In another exemplary embodiment, an aircraft structure includes an aerodynamic element and a trailing edge component coupled to an aft portion of the aerodynamic element. The trailing edge component includes a first skin comprising a first plurality of plies of carbon fiber reinforced polymer material and having a first mating region. The first plurality of plies includes a first ply with a first drop-off edge in the first mating region. A second skin includes a second plurality of plies of carbon fiber reinforced polymer material and having a second mating region affixed to the first mating region.

In a further exemplary embodiment, a method for manufacturing a trailing edge component of an aircraft is provided. The method includes forming a first skin of a first plurality of plies of carbon fiber reinforced polymer. The first skin has a first mating region and a first ply with a first drop-off edge in the first mating region. The first skin is affixed to the mating region of a second skin.

### BRIEF DESCRIPTION OF THE DRAWINGS

The various embodiments will hereinafter be described in conjunction with the following drawing figures, wherein like numerals denote like elements, and wherein:

FIG. 1 a partial perspective view of an aircraft having a winglet with a trailing edge component in accordance with an exemplary embodiment;

FIG. 2 is an enlarged view of a portion of the wing and the winglet and trailing edge component of FIG. 1;

FIG. 3 is a top plan view of the winglet and trailing edge component of FIG. 2;

FIG. 4 is a simplified cross-section view of the winglet and trailing edge component of FIG. 3, taken along line 4-4;

FIG. 5 is a close-up view of the trailing edge component of FIG. 4;

FIG. 6 is a simplified perspective view of a trailing edge component with upper and lower skins in accordance with an exemplary embodiment;

FIG. 7 is a simplified perspective view of the lower skin of the trailing edge component of FIG. 6;

FIG. 8 is a close-up cross-sectional view of the trailing edge component of FIG. 6 taken along axis 8-8;

FIG. 9 is a close-up cross-sectional view of a trailing edge component having upper and lower skins without tapered thickness profiles;

FIGS. 10-15 are simplified cross-sectional views of mating regions of trailing edge components in accordance with various exemplary embodiments; and

FIG. 16 is a schematic illustration of drop-off contour lines of a portion of a trailing edge component in accordance with an exemplary embodiment.

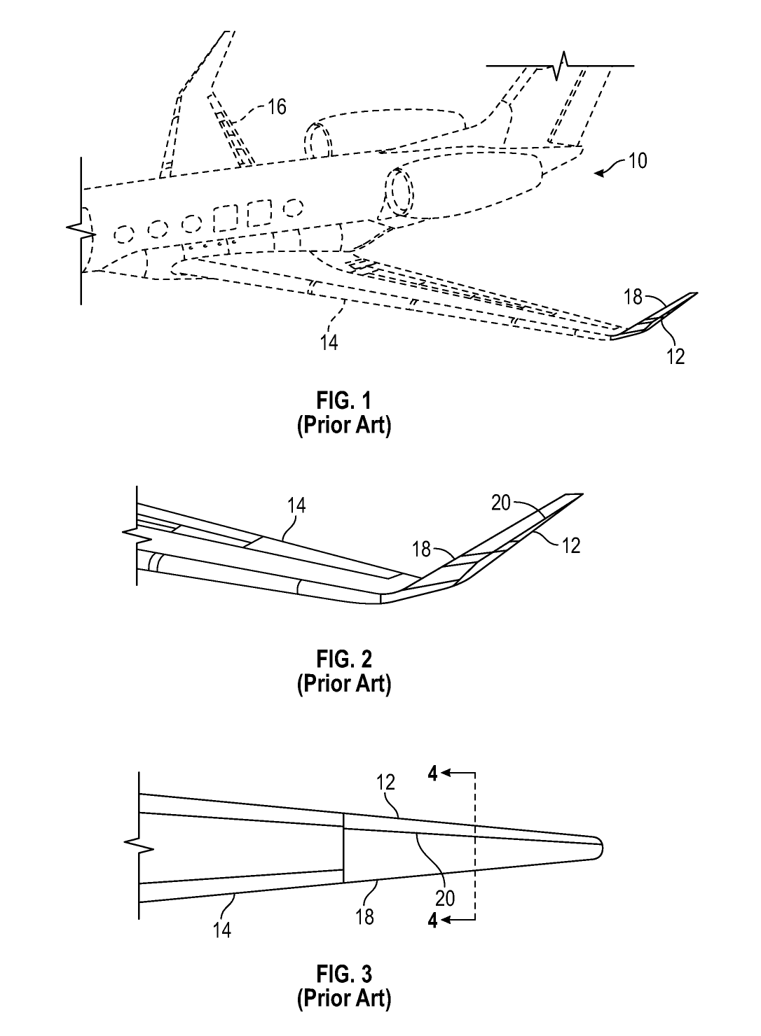

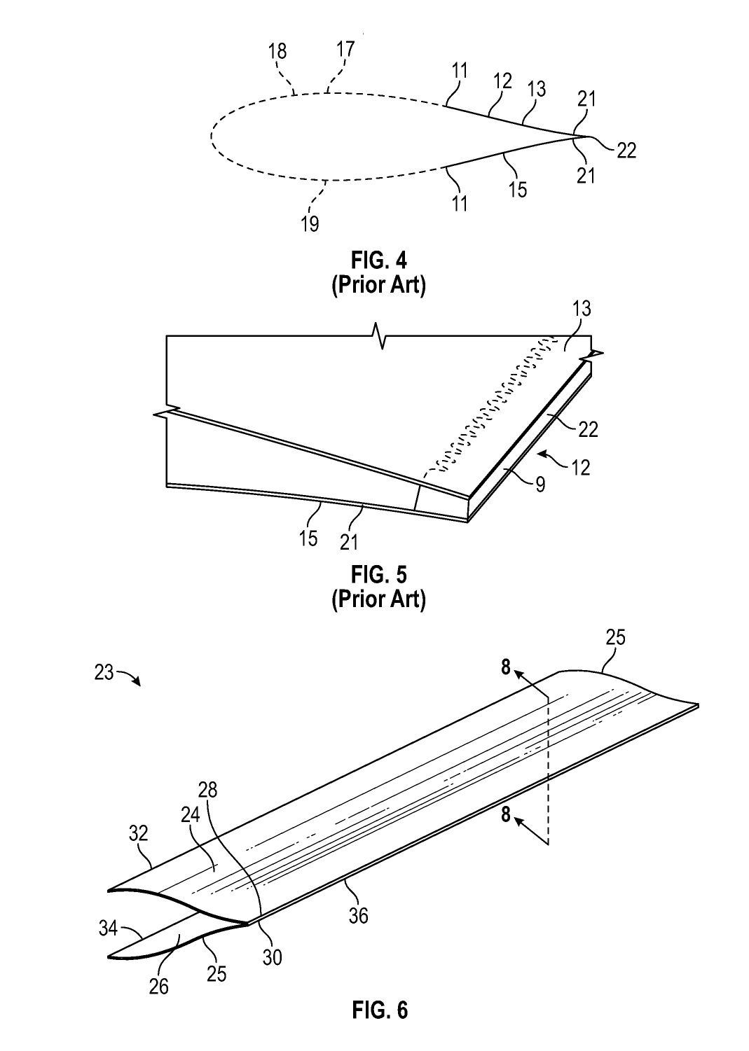

### DETAILED DESCRIPTION

The following detailed description is merely exemplary in nature and is not intended to limit the apparatus or methods disclosed herein, nor their application and uses. Furthermore, there is no intention to be bound by any theory presented in the preceding background or the following detailed description.

Various embodiments herein relate to trailing edge components for use with aircraft, articles comprising such trailing edge components, and methods of manufacturing such trailing edge components. The trailing edge components as contemplated herein are manufactured from carbon fiber reinforced polymer materials and may be used for any suitable aerodynamic element, including wings, winglets, tails, fins, stabilizers, and the like, of an aircraft that would benefit from weight reduction as compared to such elements traditionally manufactured from metals or metal alloys. Various embodiments of the trailing edge components contemplated herein also are manufactured in a manner so as to maintain desired aerodynamic contours of the trailing edge components and, hence desired aerodynamic properties of the structures to which they are affixed.

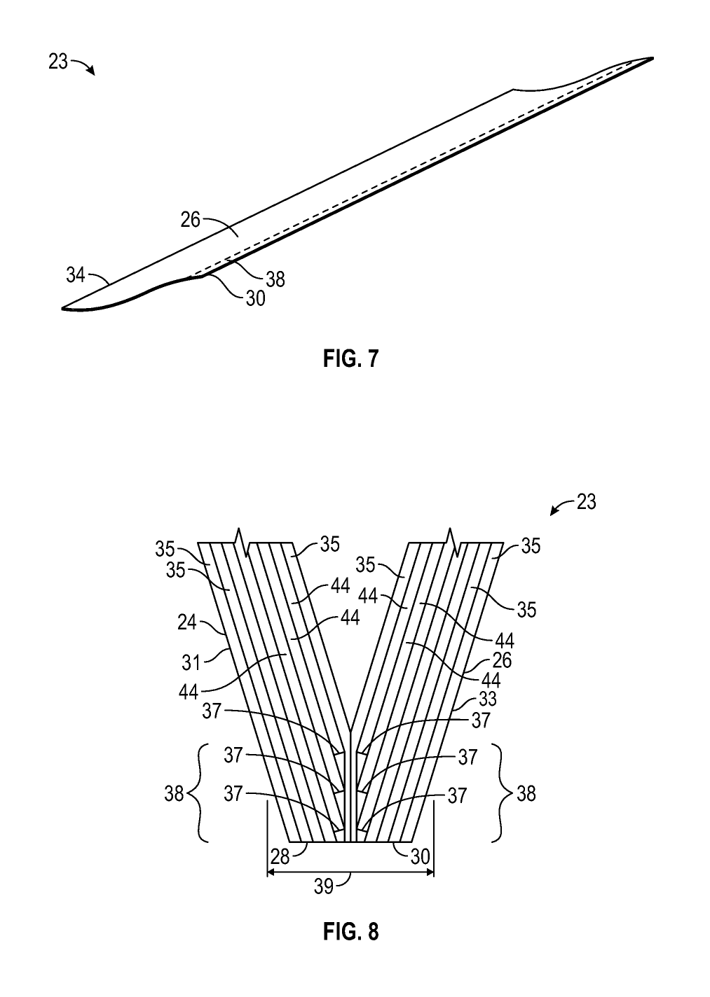

With reference now to FIGS. 6-8, in an exemplary embodiment, a trailing edge component 23 has an upper skin 24 and a lower skin 26. The upper and lower skins 24, 26 are made of a plurality of plies or layers of fiber reinforced polymer (FRP). The FRP may include a thermoset or thermoplastic polymer, such as epoxy, polyester, vinyl ester or nylon, and may contain fibers such as carbon fibers, glass fibers, ultra-high molecular weight polyethylene fibers, aluminum fibers, and the like. Such FRP materials can be in the form of, for example, braided fabric, woven fabric, unidirectional tape, sheet molding compound, or bulk molding compounds. The plies each have thickness along their surfaces that are such so as to permit the tailoring of a taper of a mating region of the skin. In this regard, if the plies are too thin, an excessive amount of plies may be required to manufacture a skin, thus increasing costs and manufacturing time of the trailing edge components. In contrast, plies with excessive thicknesses will not permit the fine tapering of the mating region of the skin within a predetermined thickness and provided tolerance of the trailing edge component, as discussed in more detail below. Exemplary plies have thickness in the range of from about 0.1016 millimeters (mm) (0.004 inches) to about 0.508 mm (0.02 inches), such as, for example, about 0.1778 mm (0.007 inches). In one embodiment, the plies are all formed of the same FRP material. In another embodiment, the plies are formed of different FRP materials. If the plies are formed of different FRP materials, in an embodiment, the plies are formed of FRP materials having sufficiently similar processing parameters so as not to overly increase manufacturing costs or complexity. In FIG. 6, the upper and lower skins 24, 26 are illustrated as mirror images of each other. However, it will be appreciated that the trailing edge component 23 is not so limited and the upper and lower skins 24, 26 can be sized and shaped depending on the application for which the trailing edge component 23 is desired to be used. Each of the upper and lower skins 24, 26 has an aft edge 28, 30, respectively, a fore edge 32, 34, respectively, and side edges 25. The trailing edge component 23 is attached to an aerodynamic element, e.g., a wing 14, winglet 18, stabilizer, or the like, of an aircraft by attaching the fore edges 32, 34 to the appropriate features on the aerodynamic element. For example, when used as a trailing edge component of a winglet (not shown), the fore edge 32 of the upper skin 24 is attached to an aft edge of an upper skin (not shown) of the winglet and the fore edge 34 of the lower skin 26 is attached to an aft edge of a lower skin (not shown) of the winglet.

In an embodiment, the lower skin 26 has a mating region 38 proximate the aft edge 30. Although not shown, the upper skin 24 also has a mating region 38 proximate its aft edge 28. In some embodiments, the mating regions 38 of both the upper and lower skins 24, 26 extend the full length of the aft edge 28, 30, respectively, to which they are proximate. Furthermore, in some embodiments, the mating regions 38 of both the upper and lower skins 24, 26 may have a depth in the range of from about 1.27 centimeters (cm) (0.5 inches) to about 5.08 cm (2 inches), for example, from about 1.905 cm (0.75 inches) to about 3.81 cm (1.5 inches), or even from about 2.54 cm (1 inch) to about 3.175 cm (1.25 inches) as measured from the aft edge 30 toward the fore edge 34 of the trailing edge component 23. Thus, as shown in FIG. 6, the trailing edge component 23 with the mating regions 38 affixed together further includes a finished trailing edge 36 comprising the aft edges 28, 30. The mating regions 38 of the trailing edge component 23 are securely affixed to one another using any method suitable for securely affixing FRP materials. Such methods include, but are not limited to the use of adhesives and bonding materials, such as FM300 epoxy adhesive available from Cytec Industries Inc. of Woodland Park, N.J., the use of fasteners, such as screws, bolts, and the like, and co-curing processes, as discussed in more detail below.

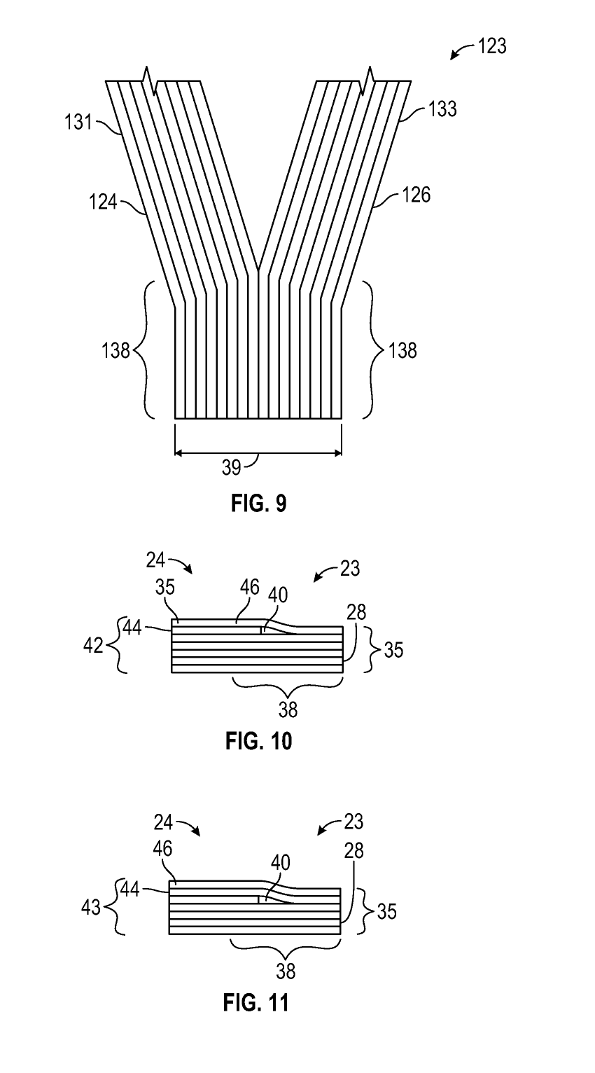

In an exemplary embodiment, as illustrated in FIG. 8, the upper skin 24, the lower skin 26, or both has a tapered thickness profile in the mating region 38 toward the aft edge 28, 30, respectively. The tapered thickness profile is used to accommodate pre-determined aerodynamic properties and, accordingly, pre-determined dimensions and contours of the trailing edge component. In particular, the upper skin 24 and lower skin 26 are manufactured according to pre-determined dimensions and surface contours that are necessitated by desired aerodynamic properties and characteristics of the trailing edge component. In other words, for the trailing edge component to exhibit desired aerodynamic properties in a particular application, the trailing edge component is designed with desired outer dimensions and with specific outer surface contours having permissible tolerances. Accordingly, the trailing edge component design is such that, at any point on the surface of the trailing edge component, the outer surface of the upper skin is a distance from the outer surface of the lower skin within a provided tolerance. Accordingly, providing tapered thickness profiles of the skin or skins in the mating regions of the skins accommodates the pre-determined distance of the skins in the mating regions within the provided tolerance. Providing tapered mating regions on one or both of the upper and lower skins 24, 26 facilitates formation of a finished trailing edge component 23 so that conventional finishing treatments such as the cutting away, sanding, or other material removal processes applied to the trailing edge component are not required. For example, as illustrated in FIG. 8, the tapered thickness profile of the upper skin 24 and lower skin 26 of trailing edge component 23 accommodates a required pre-determined thickness 39 between the outer surface 31 of upper skin 24 and the outer surface 33 of lower skin 26. In contrast, as illustrated in FIG. 9, this thickness 39 is not accommodated in trailing edge component 123 having an upper skin 124 and a lower skin 126 without tapered thickness profiles in mating regions 138. To accommodate pre-determined thickness 39, upper skin 124 and/or lower skin 126 would have to be subjected to a finishing process for removal of material from the outer surfaces 131, 133, respectively.

In an exemplary embodiment of the trailing edge component 23, as illustrated in FIGS. 6-8, the mating region 38 of the upper skin 24, the lower skin 26, or both has a “ply drop-off edge” 37 or just “drop-off” that forms the tapered mating region 38. In this regard, while one or more plies 35 of the skin extends from the fore edge 32,34 to the aft edge 28, 30 and to the side edges 25 of the skin 24, 26, respectively, one or more plies 44 has a drop-off edge 37 within the mating region 38. In other words, the drop-off edge 37 of the ply 44 does not align with either the fore edge 32, 34, the aft edge 28, 30, or the side edges 25 of the skin 24, 26, respectively. That is, in an embodiment, while the drop-off edge 37 may align with the fore edge and the side edge of the skin, it does not align with the aft edge. Alternatively, in an embodiment, while it may align with the fore edge and the aft edge of the skin, it does not align with the side edge or, in another embodiment, while it aligns with the aft edge and the side edge of the skin, it does not align with the fore edge. In another embodiment, the drop-off edge 37 may have a circuitous path and may wind according to pre-determined contours as noted above. As used herein, the term “drop-off edge” when referring to a ply means the edge of a ply that does not align with a fore edge, an aft edge, or a side edge of the trailing edge component. This staggering of the ends of plies results in a tapered mating region of the skin.

Exemplary embodiments of portions of upper skins 24 with various ply drop-off edges are illustrated in FIGS. 10-15. For example, FIG. 10 shows a simplified cross-sectional view of a portion of an upper skin 24 with an aft edge 28 and having a ply drop-off edge 40 in mating region 38. More particularly, a plurality of plies 42 form the upper skin 24 and the ply drop-off edge 40 of a ply 44 lies just beneath a top surface ply 46. The ply drop-off edge 40 shown in FIG. 10 provides a small taper to the aft edge 28. FIG. 11 shows a slightly different arrangement of the plurality of plies 42 to form a taper to the mating region 38. Like FIG. 10, the taper of FIG. 11 is created by a single ply 44, but the single ply 44 is located just beneath an additional that is ply beneath the top surface ply 46.

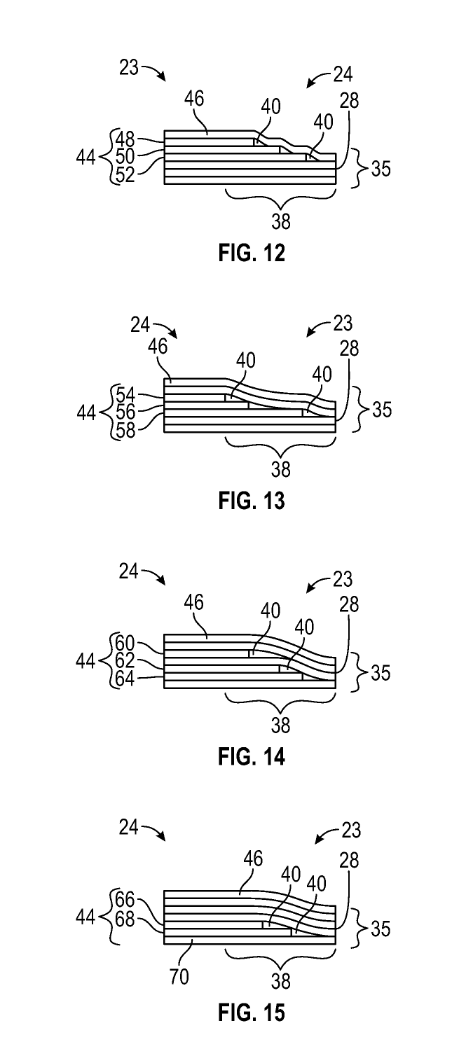

FIGS. 12-15 illustrate portions of trailing edge components 23 with varying degrees of taper. For example, FIG. 12 shows a portion of an upper skin 24 of a trailing edge component 23 comprising three substantially evenly-spaced ply drop-off edges 40 of three adjacent plies 48, 50, 52, each of which drop-off edge 40 is in the mating region 38 at a successively closer distance to the aft edge 28, and which are positioned directly beneath the top surface ply 46. FIG. 12 illustrates that using an increased number of plies 44, strategically staggered, creates greater degrees of taper of the mating region 38. FIG. 13 illustrates a portion of an upper skin 24 of a trailing edge component with three ply drop-off edges 40 of a similar arrangement of successively recessed plies 44 as in FIG. 12, but in FIG. 13 the plies 54, 56, 58 have drop-off edges 40 that are unequal distances from aft edge 28 and also are positioned beneath an additional ply that is beneath the top surface ply 46.

FIGS. 14 and 15 illustrate additional exemplary embodiments. For example, FIG. 14 illustrates the use of multiple plies 60, 62, 64 with drop-off edges 40 at staggered distances from the aft edge 28 and, in addition, are not arranged adjacent to one another. FIG. 15 demonstrates the use of plies 66, 68 that are arranged closer to a bottom surface ply 70, rather than the top surface ply 46. It will be appreciated that FIGS. 10-15 are only some of the possible exemplary embodiments of arrangements of ply drop-off edges used to effect tapering of the mating regions of trailing edge components and are not meant to be an exhaustive illustration of such arrangements. In addition, while FIGS. 10-15 illustrate tapered mating regions of upper skins, it will be appreciated that the same embodiments can be used to form tapered mating regions of lower skins of the trailing edge components contemplated herein.

In an exemplary embodiment, a method for making a trailing edge component as contemplated herein includes forming an upper skin having a mating region, a fore edge, an aft edge, and side edges and a lower skin having mating region, a fore edge, an aft edge, and side edges. In particular, as described above, the upper and lower skins are manufactured according to dimensions and surface contours that are necessitated by desired aerodynamic properties and characteristics of the trailing edge component. In other words, for the trailing edge component to exhibit desired aerodynamic properties in a particular application, the upper skin and lower skins of the component are designed with desired outer dimensions and the outer surfaces of the skins are designed with specific contours having permissible tolerances. In this regard, the trailing edge component is designed so that it will have desired thicknesses along the length and depth of the mating regions of the skins. Accordingly, at any point in the mating regions of the trailing edge component, the outer surface of the upper skin will be a desired distance from the outer surface of the lower skin within a provided tolerance.

Accordingly, in an exemplary embodiment, the method includes layering plies of FRP material to form the upper skin and layering plies of FRP material to form the lower skin. Any of the FRP materials described above with reference to FIGS. 6-8 can be used. In one embodiment, the plies all are formed of the same material. In an alternative, the plies are formed of different materials. In one embodiment, the plies are cut to size or otherwise formed to size according to their pre-determined outer dimensions before the layering. In another embodiment, the plies are substantially cut to size or otherwise substantially formed to size according to their pre-determined outer dimensions before the layering such that after the layering and curing, trimming and/or sanding of the edges of the plies is performed. The upper and lower skins are formed of plies that extend from the fore edge to the aft edge and from one side edge to the other side edge of the trialing edge component. In addition, the upper and lower skins are formed of plies having drop-off edges that are positioned in the mating region of the upper skin, the lower skin, or both so that the respective mating region(s) has a tapered thickness profile. In this regard, when the mating regions of the upper skin and the lower skin are affixed, the pre-determined distance from the outer surface of the upper skin and the outer surface of the lower skin is achieved, within the provided tolerance.

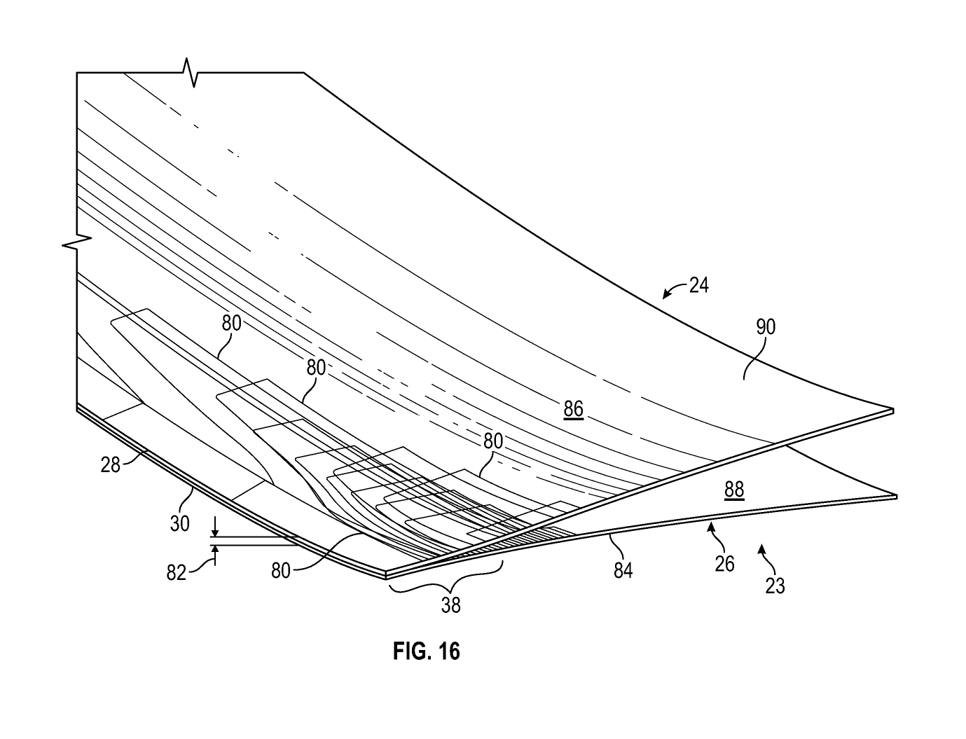

Once the plies of the upper and lower skins are layered, the mating regions of the skins are affixed together. In one embodiment, the skins are cured separately by a curing process suitable for the FRP material from which they are manufactured and then are affixed together at their mating regions using the bonding, fastening or other curing methods as described above. In an alternative method, once the plies of the upper and lower skins are layered, the skins are positioned so that the mating regions contact each other, such as in a mold, and the skins are co-cured such that the mating regions of the skins are affixed together. As used herein, “curing” includes the use of heat, chemical additives, electron beams, and/or UV radiation, with or without pressure, to cause cross-linking of the polymers of the FRP material. The trailing edge component then may be finished by sanding or trimming as needed. FIG. 16 is an illustration of drop-off contour lines 80 of trailing edge component 23 having upper skin 24 and lower skin 26. The drop-off contour lines 80 indicate the drop-off edges of plies below the surface ply 86 of upper skin 24 and the drop-off edges of plies below the surface ply 88 of lower skin 26. As described above, the position of the drop-off edges of these plies, that is, the drop-off contour lines, are based on a pre-determined thickness 82 measured between an outer surface 90 of upper skin 24 and an outer surface 84 of lower skin 26 as that thickness varies along the trailing edge component. As illustrated in FIG. 16, the upper skin 24 and/or the lower skin 26 may have plies with drop-off edges that do not align with the fore edges, the aft edges and/or the side edges and are outside of the mating regions 38. In this regard, the drop-offs can be used to thin the skins outside of the mating regions where necessary to accommodate pre-determined surface contours and thicknesses of the trailing edge component outside of the mating region.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the methods and apparatus described herein in any way. Rather, the foregoing detailed description will provide those skilled in the art with a convenient road map for implementing an exemplary embodiment of the methods and apparatus. It being understood that various changes may be made in the function and arrangement of elements described in an exemplary embodiment without departing from the scope of the methods and apparatus as set forth in the appended claims.

What is claimed is:

1. A trailing edge component comprising:
a first skin comprising a first plurality of plies of carbon fiber reinforced polymer material and having a first mating region, the first plurality of plies comprising a first ply with a first drop-off edge in the first mating region; and
a second skin comprising a second plurality of plies of carbon fiber reinforced polymer material and having a second mating region affixed to the first mating region.

2. The trailing edge component of claim 1, wherein the first mating region has a tapered cross-section.

3. The trailing edge component of claim 1, wherein the second plurality of plies comprises a second ply with a second drop-off edge in the second mating region.

4. The trailing edge component of claim 1, wherein the second mating region has a tapered cross-section.

5. The trailing edge component of claim 1, wherein the first plurality of plies of the first skin comprises the same carbon fiber reinforced polymer material.

6. The trailing edge component of claim 1, wherein the first drop-off edge in the first mating region extends from a first side of the first skin to a second side of the first skin.

7. The trailing edge component of claim 1, wherein the carbon fiber reinforced polymer material comprises a braided fabric, a woven fabric, a unidirectional tape, a sheet molding compound, or a bulk molding compound.

8. The trailing edge component of claim 1, wherein the first skin comprises an aft edge and an additional ply with an additional drop-off edge in the first mating region, wherein the first drop-off edge in the first mating region is a first distance from the aft edge of the first skin and the additional drop-off edge in the first mating region is a second distance from the aft edge of the first skin and the first distance and the second distance are unequal.

9. An aircraft structure comprising:
an aerodynamic element; and
a trailing edge component coupled to an aft portion of the aerodynamic element, wherein the trailing edge component comprises:
a first skin comprising a first plurality of plies of carbon fiber reinforced polymer material and having a first mating region, the first plurality of plies comprising a first ply with a first drop-off edge in the first mating region; and
a second skin comprising a second plurality of plies of carbon fiber reinforced polymer material and having a second mating region affixed to the first mating region.

10. The aircraft structure of claim 9, wherein the aerodynamic element comprises a wing, a winglet, a tail, a fin, a stabilizer, or a rudder.

11. The aircraft structure of claim 9, wherein the first mating region a tapered cross-section.

12. The aircraft structure of claim 9, wherein the second skin comprises a second ply with a second drop-off edge in the second mating region.

13. The aircraft structure of claim 9, wherein the first plurality of plies of the first skin comprises the same carbon fiber reinforced polymer material.

14. The aircraft structure of claim 9, wherein the first drop-off edge in the first mating region extends from a first side of the first skin to a second side of the first skin.

15. The aircraft structure of claim 9, wherein the carbon fiber reinforced polymer material comprises a braided fabric, a woven fabric, a unidirectional tape, a sheet molding compound, or a bulk molding compound.

16. The aircraft structure of claim 9, wherein the first skin comprises an aft edge and an additional ply with an additional drop-off edge in the first mating region, wherein the first drop-off edge in the first mating region is a first distance from the aft edge of the first skin and the additional drop-off edge in the first mating region is a second distance from the aft edge of the first skin and the first distance and the second distance are unequal.

17. A method for manufacturing a trailing edge component of an aircraft, the method comprising the steps of:
forming a first skin comprising a first plurality of plies of carbon fiber reinforced polymer and having a first mating region, the first skin comprising a first ply with a first drop-off edge in the first mating region; and
affixing the first skin to a second mating region of a second skin.

18. The method of claim 17, wherein a position of the first drop-off edge in the first mating region is based on a pre-determined thickness between an outer surface of the first skin and an outer surface of the second skin.

19. The method of claim 17, further comprising, before affixing, forming the second skin comprising a second plurality of plies of carbon fiber reinforced polymer, the second skin comprising a second ply that extends from a fore edge of the second skin to an aft edge of the second skin and from a first side to a second side of the first skin and a third ply with a second drop-off edge in the second mating region.

20. The method of claim 19, wherein affixing comprises contacting the first mating region and the second mating region and curing the first skin and the second skin simultaneously.
